(19) United States
(12) Patent Application Publication
(10) Pub. No.: US 2018/0093622 A1
(43) Pub. Date: Apr. 5, 2018

(54) WIRE HARNESS WITH CYLINDER VALVE PROTECTION

(71) Applicants: Tony Matijevich, Chino, CA (US); Mark Matijevich, Chino, CA (US); Terry McCrea, Chino, CA (US)

(72) Inventors: Tony Matijevich, Chino, CA (US); Mark Matijevich, Chino, CA (US); Terry McCrea, Chino, CA (US)

(21) Appl. No.: 15/721,477

(22) Filed: Sep. 29, 2017

Related U.S. Application Data
(60) Provisional application No. 62/402,815, filed on Sep. 30, 2016.

(51) Int. Cl. B60R 16/02; F02N 11/10

(52) U.S. Cl. CPC B60R 16/0207; B60W 2050/146; F02N 11/101

(57) ABSTRACT

An apparatus and a method are provided for a wiring harness configured for a compressed natural gas (CNG) powered vehicle. The wiring harness comprises an assembly of wires to convey electrical signals. The wires may be bound together by straps, cable ties, cable lacing, sleeves, electrical tape, conduit, a weave of extruded string, or a combination thereof. An exterior sleeve comprises a protective over-molding for the wires. The exterior sleeve seals substantially all connections between the wires and connector terminals of the wiring harness. The exterior sleeve may be flame-retardant and configured to withstand extreme weather conditions. A regulator controls expansion of high pressure CNG to a lower pressure gas that may be utilized in the CNG-powered vehicle. An integrated kill switch prevents engine starting during fueling. The integrated kill switch prohibits engine starting when a fill nozzle cap is improperly installed onto a fill receptacle.

### PRIORITY

This application claims the benefit of and priority to U.S. Provisional Application, entitled “Wire Harness With Cylinder Valve Protection,” filed on Sep. 30, 2016 and having application Ser. No. 62/402,815.

### FIELD

The field of the present disclosure generally relates to automotive wire harnesses. More particularly, the field of the present disclosure relates to an apparatus and a method for a wiring harness that features individualized cylinder valve protection for compressed natural gas powered vehicles.

### BACKGROUND

A cylinder is the central working part of a reciprocating engine or pump, the space in which a piston travels. Multiple cylinders are commonly arranged side by side in a bank, or engine block, which is typically cast from aluminum or cast iron before receiving precision machine work. Cylinders may be sleeved (lined with a harder metal) or sleeveless.

In automotive engineering a multi-valve or multivalve engine is one where each cylinder has more than two valves. A multi-valve engine has better breathing and may be able to operate at higher revolutions per minute (RPM) than a two-valve engine, delivering more power. A multi-valve design typically has three, four, or five valves per cylinder to achieve improved performance. Any four-stroke internal combustion engine needs at least two valves per cylinder: one for intake of air and fuel, and another for exhaust of combustion gases.

Adding more valves increases valve area and improves the flow of intake and exhaust gases, thereby enhancing combustion, volumetric efficiency, and power output. Multi-valve geometry allows the spark plug to be ideally located within the combustion chamber for optimal flame propagation. Multi-valve engines tend to have smaller valves that have lower reciprocating mass, which can reduce wear on each cam lobe, and allow more power from higher RPM without the danger of valve bounce. Some engines are designed to open each intake valve at a slightly different time, which increases turbulence, improving the mixing of air and fuel at low engine speeds. More valves also provide additional cooling to the cylinder head.

Unfortunately, at times, the cylinder valves may fail, for any number of reasons. For example, anything that interferes with the valves' cooling or creates extra heat in the valves or head can lead to premature valve failure. Moreover, deposits on the valve face and seat can have an insulating effect that slows cooling and makes the valve run hot. Similarly, poor contact between the valve and seat if the seat is too narrow, nonconcentric or off-square. If deposits build up in one spot or flake off in another, it can allow leaks that create hot spots on the valve and result in a “channeling” condition, wherein grooves erode or burn into the valve. When a cylinder valve fails, the vehicle may not operate in a safe manner. Even worse, the engine may become damaged, and may also pose a safety hazard for an operator. For example, in certain conditions, if a cylinder is faulty, then the car may stall.

What is needed, therefore, is a wiring harness that is specifically configured to allow the vehicle to safely operate in the event of a faulty cylinder valve condition, which also provides further safety redundancies.

### SUMMARY

An apparatus and a method are provided for a wiring harness configured for use with a compressed natural gas (CNG) powered vehicle. The wiring harness comprises an assembly including one or more wires configured to convey electrical signals. The one or more wires may be bound together by any of straps, cable ties, cable lacing, sleeves, electrical tape, conduit, a weave of extruded string, or a combination thereof. An exterior sleeve comprises a protective over-molding for the one or more wires. The exterior sleeve is configured to seal substantially all connections between the one or more wires and connector terminals of the wiring harness. The exterior sleeve may be flame-retardant and configured to withstand extreme weather conditions. A regulator is configured to control expansion of high pressure CNG to a lower pressure gas that may be utilized in the CNG-powered vehicle. An integrated kill switch is configured to prevent engine starting during fueling. The integrated kill switch is configured to disallow engine starting if a fill nozzle cap is not properly installed onto a fill receptacle.

In an exemplary embodiment, a wiring harness for a compressed natural gas, CNG, powered vehicle comprises: an assembly comprising one or more wires configured to convey electrical signals; an exterior sleeve comprising a protective over-molding for the one or more wires; a regulator configured as a pressure control element; and an integrated kill switch configured to prevent engine starting during fueling.

In another exemplary embodiment, the one or more wires are bound together by any of straps, cable ties, cable lacing, sleeves, electrical tape, conduit, a weave of extruded string, or a combination thereof. In another exemplary embodiment, the one or more wires are configured to supply electric power to electronic components mounted in the vehicle. In another exemplary embodiment, the electrical signals are comprised of sensor signals and information about the operation of the compressed natural gas fuel system. In another exemplary embodiment, the integrated kill switch is configured to prohibit engine starting when a fill nozzle cap is improperly installed onto a fill receptacle.

In another exemplary embodiment, the exterior sleeve is configured to seal substantially all connections between the one or more wires and connector terminals comprising the wiring harness. In another exemplary embodiment, the exterior sleeve comprises a flame-retardant element that is configured to reduce the risk of electrical fires. In another exemplary embodiment, the exterior sleeve is configured to withstand extreme weather conditions and meets the IEC IP67 rating.

In another exemplary embodiment, the regulator is configured to control expansion of high pressure CNG to a lower pressure gas that may be utilized in the CNG-powered vehicle. In another exemplary embodiment, the regulator further comprises a circulation bowl configured to receive heated engine coolant to prevent moisture buildup and freezing within the regulator during the expansion of the high pressure CNG.

In another exemplary embodiment, the one or more wires are configured to be coupled with a centralized, weather-resistant fuse box. In another exemplary embodiment, the fuse box is configured to provide convenient access to one or more fuses of a CNG fuel system. In another exemplary embodiment, the one or more fuses are configured to each protect an individual engine cylinder. In another exemplary embodiment, the one or more fuses are comprised of any of ATC, AGU and ANL fuses. In another exemplary embodiment, the fuse box is comprised of a number of fused circuits ranging between 2 fused circuits and 12 fused circuits. In another exemplary embodiment, the fuse box comprises an independent fuse panel, such that each fused circuit includes at least a power input wire and an output wire. In another exemplary embodiment, the fuse box comprises a ganged fuse panel, such that electrical power is shared among the number of fused circuits.

In an exemplary embodiment, a method for preventing engine starting of a compressed natural gas, CNG, powered vehicle comprises: detecting activation of an ignition system of the vehicle; detecting an improper nozzle fill cap installation onto a fill receptacle; preventing engine starting during the improper nozzle fill cap installation; indicating the improper nozzle fill cap installation to an operator of the vehicle; and allowing engine starting in absence of the improper nozzle fill cap installation,

In another exemplary embodiment, indicating comprises displaying visual alerts such as lights, icons, and graphics on a dashboard of the vehicle. In another exemplary embodiment, indicating further comprises providing audible alerts that correspond to the visual alerts.

### BRIEF DESCRIPTION OF THE DRAWINGS

The drawings refer to embodiments of the present disclosure in which:

FIG. 1 illustrates a perspective view of an exemplary wiring harness according to one embodiment;

FIG. 2A illustrates an isometric perspective view of the exemplary wiring harness of FIG. 1, as disposed with respect to an exemplary vehicle chassis;

FIG. 2B illustrates a top view of the exemplary wiring harness and vehicle chassis of FIG. 2A; and

FIG. 3 illustrates a flow diagram of an exemplary conditional ignition methodology.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first sensor,” may be made. However, the specific numeric reference should not be interpreted as a literal sequential order but rather interpreted that the “first sensor” is different than a “second sensor.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In one aspect, a wiring harness for a compressed natural gas vehicle, is disclosed, comprising: an assembly of one or more cables that are configured to transmit signals and electrical power, wherein the cables are bound together; an exterior sleeve comprising a resistant over-molding technology, configured so as to completely seal all connections between the cables; a regulator that is configured as a pressure control element; and an integrated kill switch that is configured so as to not allow the engine to start if a fill nozzle cap is not on the fill receptacle.

In another aspect, the cables are bound together by any of straps, cable ties, cable lacing, sleeves, electrical tape, conduit, and a weave of extruded string. In yet another aspect, the exterior sleeve comprises a flame-retardant element that is configured to lower the risk of electrical fires.

In one aspect, the exterior sleeve is configured to withstand extreme weather conditions and meets the IEC IP67 rating. In another aspect, the wiring harness is coupled to a centralized, weather-resistant fuse box. In yet another aspect, the fuse box is located under the vehicle, on a shock absorber cross member. In one aspect, the fuse box is located near a mid-ship cylinder. In another aspect, the fuse box comprises one or more fuses that are configured so as to protect each engine cylinder individually. In one aspect, the fuse box comprises anywhere from 2 circuits to 12 circuits. In another aspect, the fuse box comprises at least one of ATC, AGU and ANL fuses.

In one aspect, a method for preventing ignition of a compressed natural gas vehicle is disclosed, comprising: inserting a vehicle-starting element into the ignition system of the vehicle; determining whether a nozzle fill cap is appropriately coupled to a fill receptacle; preventing ignition of the vehicle if the nozzle fill cap is not coupled to the fill receptacle; and providing one or more visual alerts to a user so that the nozzle fill cap may be appropriately coupled to the fill receptacle.

In general, the present disclosure describes an apparatus and a method for a wiring harness with individualized fused engine cylinder protection. In one embodiment, a kill switch is integrated to prevent engine starting during fueling. It is envisioned that the harness is constructed so as to adhere to original equipment manufacturer (OEM) standards. In one embodiment, the wiring harness is adapted to provide substantial benefits when used in conjunction with a compressed natural gas (CNG) vehicle.

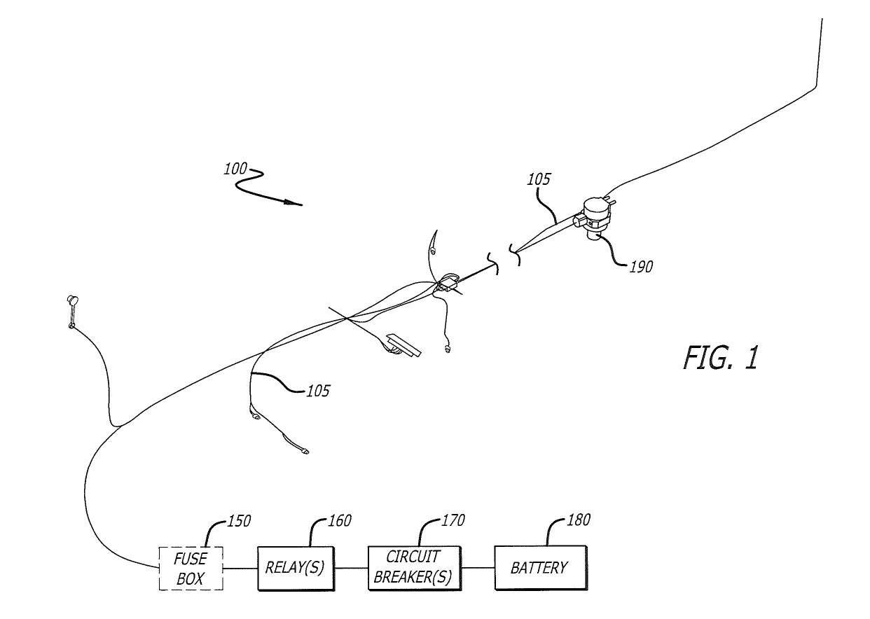

In one embodiment, shown in FIG. 1, an exemplary wiring harness 100 features an assembly of one or more cables/wires that are configured so as to transmit signals or electrical power. The cables 105 may be bound together by straps, cable ties, cable lacing, sleeves, electrical tape, conduit, a weave of extruded string, or a combination thereof. Preferably, the wiring harness 100 features an exterior sleeve that features a resistant over-molding technology, so as to completely seal all connections between the various wires and connector terminals of the wiring harness 100.

It should be understood that the role of the wiring harnesses 100 is to electrically connect electronic devices and electrical components mounted in automobiles and machines, and especially vehicles having a compressed natural gas (CNG) fuel system, for the conveyance of information and power. The wiring harness 100 is comprised of individual cables 105 that play respective roles of supplying power, sending sensor signals, transmitting information on operations and the like.

I. Wiring Harness with Individualized Cylinder Protection

In one embodiment, by securing the many cables 105 into the wiring harness 100, the wires and cables can be better secured against the adverse effects of vibrations, abrasions, and moisture, without limitation. By constricting the wires into a non-flexing arrangement, usage of space is optimized, and the risk of a short is decreased. Moreover, since only one harness must be installed (as opposed to multiple wires/cables), the overall installation time is decreased and the process may be more easily standardized. Binding the wires into a flame-retardant sleeve also lowers the risk of electrical fires. In one embodiment, the sleeve is designed to withstand the most extreme weather conditions and meets the IEC IP67 rating.

In one embodiment, the wiring harness 100 is connected to a centralized, weather-resistant fuse box 150. The fuse box 150 is configured to provide quick and convenient access to a fuel system's fuses, for example. In one embodiment, the fuse box 150 is located under the vehicle, on the shock absorber cross member, which, may be near the mid-ship cylinder, for example. It is envisioned that the fuses are configured so as to protect each engine cylinder individually, in parallel, so if there is a fault in one engine cylinder, the next engine cylinder inline will not be affected. Of course, it should be understood that a plurality of auxiliary components may be added to the fuse box for use with other components with respect to the vehicle. The exact location of the fuse box 150 may be varied. Moreover, the exact connections to and from the fuse box 150 may be varied without limitation.

In one embodiment, the fuse box 150 is configured to be utilized with 12-volt and 24-volt electrical systems, including, for example, a battery 180. In one embodiment, the fuse box 150 may be communicatively coupled to the battery 180 via a series of relays 160 and circuit breakers 170. In one embodiment, the circuit breakers 170 are configured to protect one or more of the electrical circuits discussed herein from damage caused by overcurrent, overload or short circuit conditions. It should be understood that the relays 160 and circuit breakers 170 are optional, and may be wired or disposed within the circuit in any of various ways without limitation.

Depending on the application, the fuse box 150 may feature a number of fused circuits ranging between 2 fused circuits and 12 fused circuits. It is envisioned that the fuse box 150 may feature various types of fuses, including by way of non-limiting example, ATC, AGU and ANL fuses. In some embodiments, the fuse box 150 may be independent, wherein each fused circuit has an input wire and an output wire, or ganged, wherein power is shared among all the circuits. As will be appreciated, independent fuse blocks require two wires to be run for each fuse, one from the power source, and one to the accessory. A ganged fuse panel requires a heavier power wire to be run to the panel, and a single wire runs out to each accessory in the system.

As shown in the embodiment of FIG. 1, the wiring harness 100 includes a regulator 190 that is configured as a pressure control element. In one embodiment, the regulator 190 may be utilized in a CNG-powered vehicle. In such instances, it should be appreciated that the expansion of high pressure CNG to a lower pressure gas creates a measurable temperature drop. To prevent moisture from freezing inside the regulator 190 and creating an undesirable clog situation, heated engine coolant may be circulated within a circulation bowl of the regulator 190.

In one embodiment, the wiring harness 100 may be created using one or more automated procedures. However, it should be understood that the wiring harness 100 may also be made by hand. Indeed, cables 105 may be routed through sleeves, terminals may be crimped onto the cables 105, one sleeve may be inserted into another, multiple strands of cables 105 may be fastened using any number of clamps, ties and the like, without limitation.

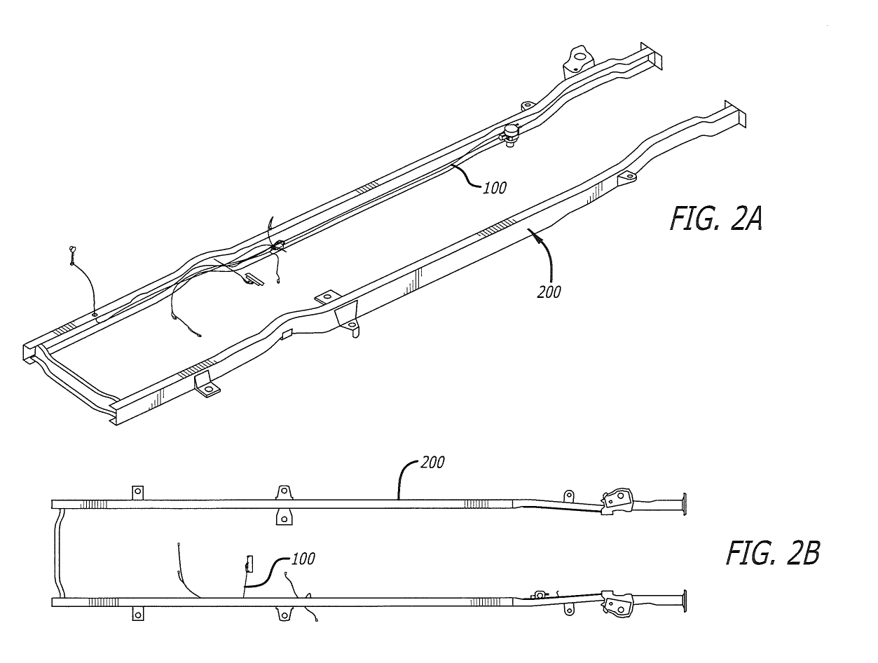

As shown in FIGS. 2A and 2B, the wiring harness 100 may be disposed onto a vehicle chassis 200. The wiring harness 100 may be fastened to the vehicle chassis 200 using any of various suitable methods, including, for example, cable ties, adhesives, etc.

II. Integrated Kill Switch

In one embodiment, the wiring harness 100 features an integrated kill switch that is configured to not allow the engine to start if a fill nozzle cap is not properly installed onto a fill receptacle. More specifically, it is envisioned that the kill switch is a safety feature that does not allow an operator to start the vehicle while the vehicle is fueling.

In general, the fuel receptacle may be found on a driver's side of the vehicle, but in some embodiments, it is located on a passenger side as well. Generally, the operator parks the vehicle with the fuel receptacle-side closest to the refueling station. Thereafter, the operator generally turns the ignition switch to a locked position, and applies a parking brake. The fuel receptacle door may then be opened by pushing on a lever inside the vehicle. It should be understood that the refueling procedure may vary with the refueling station. Finally, the operator removes the fill nozzle cap, or dust cap, from the fuel receptacle.

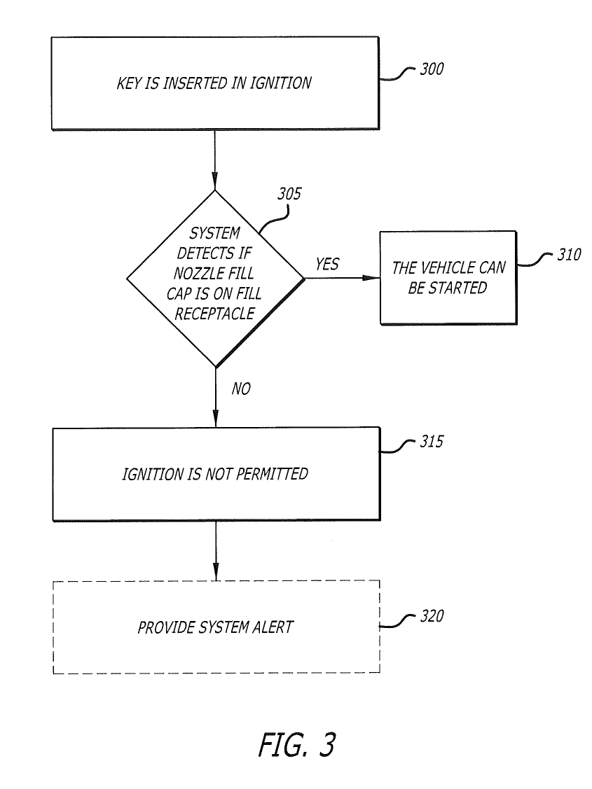

FIG. 3 illustrates an exemplary flow diagram of a conditional ignition methodology intended to further increase the safety of fueling the vehicle. At block 300, a vehicle starting element such as a key, FOB, or transponder is inserted into the ignition system. It should be understood that the purpose of the ignition system is to create a spark that will ignite a fuel-air mixture in cylinders of the engine. Once the ignition is activated, such as by inserting the key into the ignition, at block 305 the system detects if a nozzle fill cap is properly installed onto a fill receptacle. In some embodiments, the nozzle fill cap may be comprised of a dust cap, without limitation. If the nozzle fill cap is properly coupled to the fill receptacle, then the vehicle's engine may be started, as shown at block 310. On the contrary, however, if the system detects that the nozzle fill cap is improperly installed onto the fill receptacle, then engine starting is prohibited at block 315. In some embodiments, as shown in block 320, one or more system alerts may be displayed to the vehicle's operator. It is envisioned that such alerts may include lights, graphics and corresponding sounds that are communicated on the vehicle's dashboard, or via a separate gauge, for example.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A wiring harness for a compressed natural gas, CNG, powered vehicle, the wiring harness comprising:
an assembly comprising one or more wires configured to convey electrical signals;
an exterior sleeve comprising a protective over-molding for the one or more wires;
a regulator configured as a pressure control element; and
an integrated kill switch configured to prevent engine starting during fueling.

2. The wiring harness of claim 1, wherein the one or more wires are bound together by any of straps, cable ties, cable lacing, sleeves, electrical tape, conduit, a weave of extruded string, or a combination thereof.

3. The wiring harness of claim 1, wherein the one or more wires are configured to supply electric power to electronic components mounted in the vehicle.

4. The wiring harness of claim 1, wherein the electrical signals are comprised of sensor signals and information about the operation of the compressed natural gas fuel system.

5. The wiring harness of claim 1, wherein the exterior sleeve is configured to seal substantially all connections between the one or more wires and connector terminals comprising the wiring harness.

6. The wiring harness of claim 5, wherein the exterior sleeve comprises a flame-retardant element that is configured to reduce the risk of electrical fires.

7. The wiring harness of claim 5, wherein the exterior sleeve is configured to withstand extreme weather conditions and meets the IEC IP67 rating.

8. The wiring harness of claim 1, wherein the regulator is configured to control expansion of high pressure CNG to a lower pressure gas that may be utilized in the CNG-powered vehicle.

9. The wiring harness of claim 8, wherein the regulator further comprises a circulation bowl configured to receive heated engine coolant to prevent moisture buildup and freezing within the regulator during the expansion of the high pressure CNG.

10. The wiring harness of claim 1, wherein the one or more wires are configured to be coupled with a centralized, weather-resistant fuse box.

11. The wiring harness of claim 10, wherein the fuse box is configured to provide convenient access to one or more fuses of a CNG fuel system.

12. The wiring harness of claim 11, wherein the one or more fuses are each configured to protect an individual engine cylinder.

13. The wiring harness of claim 11, wherein the one or more fuses are comprised of any of ATC, AGU and ANL fuses.

14. The wiring harness of claim 10, wherein the fuse box is comprised of a number of fused circuits ranging between 2 fused circuits and 12 fused circuits.

15. The wiring harness of claim 14, wherein the fuse box comprises an independent fuse panel, such that each fused circuit includes at least a power input wire and an output wire.

16. The wiring harness of claim 14, wherein the fuse box comprises a ganged fuse panel, such that electrical power is shared among the number of fused circuits.

17. The wiring harness of claim 1, wherein the integrated kill switch is configured to prohibit engine starting when a fill nozzle cap is improperly installed onto a fill receptacle.

18. A method for preventing engine starting of a compressed natural gas, CNG, powered vehicle, comprising:
detecting activation of an ignition system of the vehicle;
detecting an improper nozzle fill cap installation onto a fill receptacle;
preventing engine starting during the improper nozzle fill cap installation;
indicating the improper nozzle fill cap installation to an operator of the vehicle; and
allowing engine starting in absence of the improper nozzle fill cap installation.

19. The method of claim 18, wherein indicating comprises displaying visual alerts such as lights, icons, and graphics on a dashboard of the vehicle.

20. The method of claim 19, wherein indicating further comprises providing audible alerts that correspond to the visual alerts.
